(19) United States
(12) Patent Application Publication
(10) Pub. No.: US 2022/0209241 A1
(43) Pub. Date: Jun. 30, 2022

(54) ELECTRODE PLATE, ELECTROCHEMICAL DEVICE, AND ELECTRONIC DEVICE

(71) Applicants: Ningde Amperex Technology Limited, Ningde City (CN); Dongguan Amperex Technology Limited, Dongguan City (CN)

(72) Inventor: Baozhang LI, Ningde (CN)

(73) Assignees: Ningde Amperex Technology Limited, Ningde City (CN); Dongguan Amperex Technology Limited, Dongguan City (CN)

(21) Appl. No.: 17/561,206

(22) Filed: Dec. 23, 2021

(30) Foreign Application Priority Data
Dec. 31, 2020 (CN) 202011623886.7

(51) Int. Cl. H01M 4/66; H01M 4/62; H01M 4/131; H01M 4/583; H01M 10/0525

(52) U.S. Cl. CPC H01M 4/66; H01M 4/622; H01M 10/0525; H01M 4/583; H01M 4/131

(57) ABSTRACT

An electrode plate includes a current collector and an active material layer located on the current collector. The active material layer includes a first composite particle and a second composite particle. A first binder particle and all first active material particles in contact with the first binder particle constitute the first composite particle. A second binder particle and all second active material particles in contact with the second binder particle constitute the second composite particle. In a thickness direction of the active material layer, the first composite particle is closer to the current collector than the second composite particle. A number of the first active material particles contained in the first composite particle is smaller than a number of the second active material particles contained in the second composite particle. Both composition of the first binder particle and composition of the second binder particle include polypropylene. This electrode plate has increased an ohmic resistance of the active material layer and reduced an electrochemical reaction impedance.

### CROSS-REFERENCE TO RELATED APPLICATIONS

This application claims priority to Chinese Patent Application No. 202011623886.7 filed on Dec. 31, 2020, the whole disclosure of which is incorporated herein by reference.

### TECHNICAL FIELD

This application relates to the field of electrochemical energy storage, and in particular, to an electrode plate, an electrochemical device, and an electronic device.

### BACKGROUND

With the development and progress of electrochemical devices (such as a lithium-ion battery), higher requirements have been posed on the safety performance of the electrochemical devices. Although the current technology for improving the electrochemical devices can improve the safety performance of the electrochemical devices to some extent, the improvement is still unsatisfactory and more improvements are expected.

### SUMMARY

Embodiments of this application provide an electrode plate. The electrode plate includes a current collector and an active material layer located on the current collector. In some embodiments, the active material layer includes a first composite particle and a second composite particle. The first composite particle includes a first active material particle and a first binder particle. The first binder particle and the first active material particle in contact with the first binder particle constitute the first composite particle. The second composite particle includes a second active material particle and a second binder particle. The second binder particle and the second active material particle in contact with the second binder particle constitute the second composite particle. In a thickness direction of the active material layer, the first composite particle is closer to the current collector than the second composite particle. A number of the first active material particles contained in the first composite particle is smaller than a number of the second active material particles contained in the second composite particle. Both composition of the first binder particle and composition of the second binder particle include polypropylene.

In some embodiments, the active material layer includes a first active material layer and a second active material layer. The first active material layer is disposed between the current collector and the second active material layer. The first active material layer includes the first composite particle. The second active material layer includes the second composite particle.

In some embodiments, a particle diameter of the first binder particle is 0.06 μm to 6 μm, a particle diameter of the second binder particle is 0.06 μm to 6 μm, a particle diameter of the first active material particle is 2.31 μm to 30 μm, and a particle diameter of the second active material particle is 0.1 μm to 2.3 μm.

In some embodiments, the active material layer further includes a third binder. The third binder includes at least one of polyacrylic acid sodium salt, polyacrylic acid, polyacrylate, polymethyl methacrylate, polyacrylonitrile, polyamide, or sodium carboxymethyl cellulose.

In some embodiments, a mass percent of the first binder in the first active material layer is A, and a mass percent of the second binder in the second active material layer is B, where A<B. In some embodiments, a ratio of A to B is 1:9 to 2:3.

In some embodiments, on a cross section of the electrode plate in a thickness direction of the electrode plate, a number of the first binder particles per unit area of the first active material layer is less than a number of the second binder particles per unit area of the second active material layer.

In some embodiments, the electrode plate is a positive electrode plate. The first active material particle and the second active material particle each is independently selected from at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadium oxide, lithium manganese oxide, lithium nickel oxide, lithium nickel cobalt manganese oxide, lithium-rich manganese-based material, or lithium nickel cobalt aluminum oxide.

In some embodiments, the electrode plate is a negative electrode plate. The first active material particle and the second active material particle each is independently selected from at least one of artificial graphite, natural graphite, mesocarbon microbead, soft carbon, hard carbon, silicon, tin, a silicon-carbon compound, a silicon-oxygen compound, or lithium titanium oxide.

Another embodiment of this application provides an electrochemical device. The electrochemical device includes a positive electrode plate, a negative electrode plate, and a separator disposed between the positive electrode plate and the negative electrode plate. At least one of the positive electrode plate or the negative electrode plate is the electrode plate described above.

An embodiment of this application further provides an electronic device, including the electrochemical device.

In this application, the number of the first active material particles contained in the first composite particle is smaller than the number of the second active material particles contained in the second composite particle, thereby reducing the transmission resistance of the lithium ions in the part that is of the active material layer and close to the current collector, reducing the kinetic transmission resistance of the lithium ions of the active material layer, and enhancing the kinetic performance of the electrochemical device. In addition, both the composition of the first binder particle and the composition of the second binder particle in this application include polypropylene, thereby improving the strength of bonding the first active material particle and the second active material particle to the current collector. In addition, the hardness of the polypropylene is relatively low, and the use of the polypropylene in the active material layer reduces adverse effects on a compacted density of the active material layer.

### BRIEF DESCRIPTION OF DRAWINGS

FIG. 1 is a schematic diagram of an electrode assembly of an electrochemical device according to an embodiment of this application.

FIG. 2 to FIG. 6 are schematic sectional views of an electrode plate according to some embodiments of this application.

### DETAILED DESCRIPTION OF EMBODIMENTS

The following embodiments enable a person skilled in the art to understand this application more comprehensively, but without limiting this application in any way.

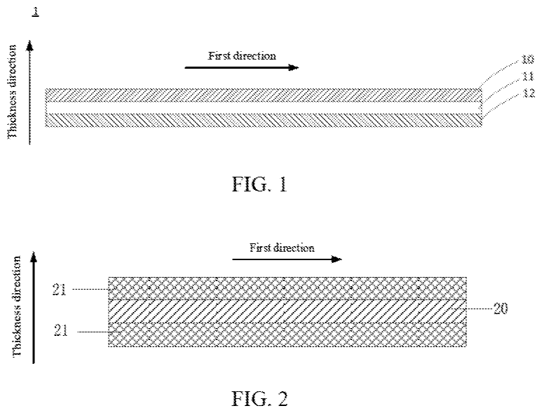

FIG. 1 is a sectional view of an electrode assembly of an electrochemical device according to an embodiment of this application. Understandably, when the electrode assembly is a jelly-roll structure, FIG. 1 is a sectional view of an electrode assembly expanded along a first direction. In some embodiments, the first direction is perpendicular to a winding direction. The electrochemical device may include an electrode assembly 1. The electrode assembly 1 may include a positive electrode plate 10, a negative electrode plate 12, and a separator 11 disposed between the positive electrode plate 10 and the negative electrode plate 12.

As shown in FIG. 2, an embodiment of this application provides an electrode plate. The electrode plate includes a current collector 20 and an active material layer 21 disposed on the current collector 20. Understandably, although the active material layer 21 shown in FIG. 2 is disposed on both sides of the current collector 20, the drawing is merely exemplary but not intended to limit this application. The active material layer 21 may be disposed on just one side of the current collector 20. Although the current collector 20 and the active material layer 21 shown in FIG. 2 contact each other directly, in some embodiments, an additional layer may be disposed between the current collector 20 and the active material layer 21.

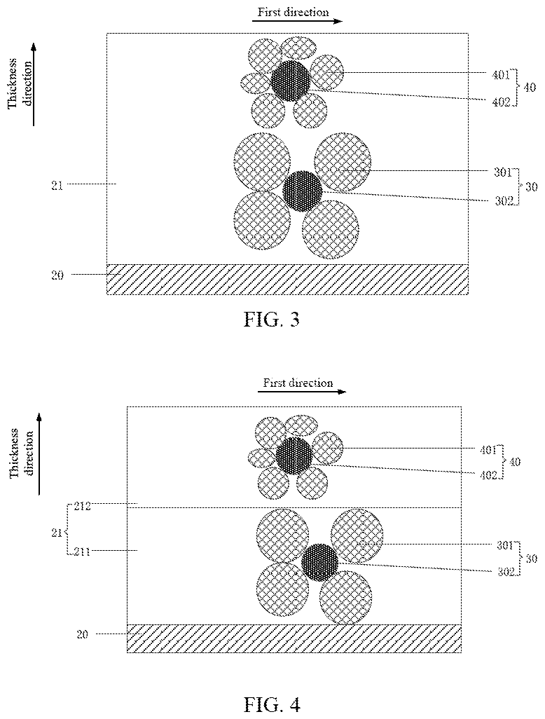

As shown in FIG. 3, in some embodiments, the active material layer 21 includes a first composite particle 30 and a second composite particle 40. The first composite particle 30 includes a first active material particle 301 and a first binder particle 302. The first binder particle 302 and the first active material particle 301 in contact with the first binder particle constitute the first composite particle 30. The second composite particle 40 includes a second active material particle 401 and a second binder particle 402. The second binder particle 402 and the second active material particle 401 in contact with the second binder particle constitute the second composite particle 40.

Understandably, for simplicity, just one of the first active material particles 301 and one of the second binder particles 402 are identified in FIG. 3. In addition, although just one first composite particle 30 and one second composite particle 40 are shown in FIG. 3, the drawing is merely exemplary but not intended to limit this application. The active material layer 21 may further include other first composite particles 30 and second composite particles 40 not shown. In addition, in the active material layer 21, a first active material particle 301 and/or a first binder particle 302 that do not constitute a first composite particle 30 may exist, and a second active material particle 401 and/or a second binder particle 402 that do not constitute a second composite particle 40 may exist

In some embodiments, in a thickness direction of the active material layer 21, the first composite particle 30 is closer to the current collector 20 than the second composite particle 40. The number of the first active material particles 301 contained in the first composite particle 30 is smaller than the number of the second active material particles 401 contained in the second composite particle 40. Understandably, FIG. 3 is merely illustrative, and shows the active material layer 21 located on one side of the current collector 20, so as to facilitate description of the embodiment. The number of active material layers 21, and the shape and specific size of the particles are not intended to limit this application.

During the charging and discharging of the electrochemical device, the second active material particles 401 far from the current collector 20 are in sufficient contact with the electrolytic solution, and the transmission speed of lithium ions in a liquid phase is much higher than the transmission speed in a solid phase. Consequently, a deintercalation speed of the lithium ions in a part that is of the active material layer 21 and far from the current collector 20 is higher than a deintercalation speed of the lithium ions in a part that is of the active material layer 21 and close to the current collector 20. The transmission of the lithium ions in the part that is of the active material layer 21 and close to the current collector 20 is a main factor of reaction limitation. In addition, the binder in the active material layer 21 reduces the electron conductivity and the ion conductivity of the active material layer 21. If the number of the first active material particles 301 bonded around a single first binder particle 302 close to the current collector 20 is larger than the number of the second active material particles 401 bonded around a single second binder particle 402 far away from the current collector 20, the transmission resistance of the part that is of the active material layer 21 and close to the current collector 20 will further increase. The number of the first active material particles 301 contained in the first composite particle 30 is smaller than the number of the second active material particles 401 contained in the second composite particle 40, thereby reducing the transmission resistance of the part that is of the active material layer 21 and close to the current collector 20 and that limits the transmission of lithium ions, reducing the kinetic transmission resistance of the lithium ions of the entire active material layer 21, and enhancing the kinetic performance of the electrochemical device. In addition, because the number of the first active material particles 301 contained in the first composite particle 30 is smaller than the number of the second active material particles 401 contained in the second composite particle 40, the number of the second active material particles 401 contained in the second composite particle 40 is relatively large, thereby increasing a surface ohmic resistance of the active material layer 21. When the active material layer of the positive electrode plate 10 is short-circuited to the active material layer of the negative electrode plate 12, a high resistance of the active material layer will produce a high short-circuit resistance of the active material layer, thereby improving the safety of the electrochemical device.

In some embodiments, the number of particles in this application may be determined by the following steps: cutting the electrode plate to obtain a cross section of the electrode plate in the thickness direction of the electrode plate, and then scanning the cross section in the thickness direction of the electrode plate by using a scanning electron microscope (SEM), so that the number of particles is the corresponding number of particles displayed in the cross section.

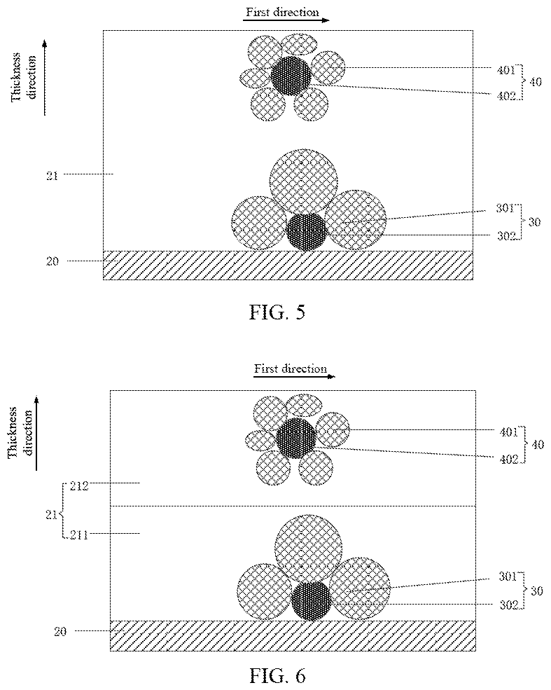

In some embodiments, both the composition of the first binder particle 302 and the composition of the second binder particle 402 include polypropylene. Generally, in order to improve the bonding between the active material layer 21 and the current collector 20, the content of the binder is increased or a highly adhesive binder is adopted. However, the increased content of the binder exerts a limited effect on the improvement of the bonding force. For example, when the mass percent of the binder polyvinylidene difluoride (PVDF) in the active material layer is increased from 1% to 3%, the bonding strength of the wet active material layer infiltrated by the electrolytic solution is increased from 9 N/m to 18 N/m. The improvement is limited. Moreover, this decreases the content of the active material, and thereby decreases the energy density. In addition, the hardness of some highly adhesive binders currently available is relatively high, and the hardness of the active material is also relatively large. If the compacted density is increased in a cold-pressing stage of the electrode plate, the electrode plate is very likely to snap off, thereby limiting the cold-pressed density of the electrode plate and reducing the energy density of the electrochemical device. Both the composition of the first binder particle 302 and the composition of the second binder particle 402 in this application include polypropylene. The polypropylene can bond the active material particles firmly together. Moreover, as shown in FIG. 5, when a part of the surface of the polypropylene particle contacts the current collector 20, the polypropylene particle can bond well to the current collector 20, thereby improving the bonding between the active material layer 21 and the current collector 20. In addition, the hardness of the polypropylene is relatively low, thereby reducing the adverse effect of the binder of high hardness on the compacted density of the electrode plate.

As shown in FIG. 4 and FIG. 6, in some embodiments, the active material layer 21 includes a first active material layer 211 and a second active material layer 212. The first active material layer 211 is disposed between the current collector 20 and the second active material layer 212. The first active material layer 211 includes the first composite particle 30. The second active material layer 212 includes the second composite particle 40. Therefore, the first composite particle 30 and the second composite particle 40 may be located in the same layer or in different layers, as long as the first composite particle 30 is closer to the current collector and the second composite particle 40 is farther away from the current collector.

In some embodiments, the particle diameter range of the first binder particle 302 is 0.06 μm to 6 μm. If the particle diameter of the first binder particle 302 is too small, the first binder particles 302 themselves are prone to agglomerate and bond to each other and thereby fail to sufficiently bond with the first active material particle 301. Consequently, the binder particles concentrate in local regions, thereby affecting the bonding effect. In addition, if the particle diameter of the first binder particle 302 is too small, the first binder particle 302 merely fills packing pores between the first active material particles 301, and is less likely to coat the surface of the first active material particles 301. Consequently, the bonding force between the first binder particle 302 and the first active material particle 301 is relatively low, and the resistance of the active material layer decreases. If the particle diameter of the first binder particle 302 is too large, the specific surface area is reduced, the pores between the first active material particles 301 are unable to be filled efficiently, and pores are generated between the first binder particle and the first active material particle 301. Consequently, the area of coating on the surface of the first active material particle 301 decreases, the gap between the first active material particles 301 is enlarged, the lithium ion transmission path is lengthened, and the electrochemical reaction impedance increases.

It needs to be noted that the particle diameter of the first binder particle 302 means the particle diameter of the first binder particle 302 in a single first composite particle 30. In the electrode plate, when there are a plurality of first composite particles 30, the particle diameter of the first binder particle 302 of all the first composite particles 30 may fall in the range of 0.06 μm to 6 μm; or the particle diameter of the first binder particle 302 of a part of the first composite particles 30 may fall in the range of 0.06 μm to 6 μm.

In some embodiments, the particle diameter of the particles in this application (for example, the first active material particle, the second active material particle, the first binder particle, the second binder particle, and the like) in this application may be determined by the following method: obtaining a cross-sectional area of the particle; and determining that a diameter of a circle with an area equal to the cross-sectional area is equivalent to the particle diameter of the particle. The cross-sectional area of the particle may be obtained by the following steps: cutting the electrode plate to obtain a cross section of the electrode plate in the thickness direction of the electrode plate, and then scanning the cross section of the particle in the thickness direction of the electrode plate by using a scanning electron microscope (SEM), thereby determining the cross-sectional area of the particle. The test steps are described below:

Sampling: Disassembling an electrochemical device (such as a lithium-ion battery), taking out an electrode plate, and soaking the electrode plate in a dimethyl carbonate (DMC) solution for 6 hours to remove the residual electrolytic solution, and finally drying the electrode plate in an oven.

Preparing a specimen: Cutting out a to-be-tested section of the electrode plate with a knife, that is, a section of the active material layer sectioned along the thickness direction; pasting the specimen onto paraffin by using a heating plate, and polishing the to-be-tested section with an ion polisher IB-195020 CCP, so that an SEM specimen is obtained after the surface of the section is smooth.

Testing: Observing the microstructure of the active material layer in the thickness direction by using a scanning electron microscope JEOL6390.

Understandably, the test method is merely exemplary, and other appropriate methods may apply.

In some embodiments, the particle diameter range of the second binder particle 402 is 0.06 μm to 6 μm. If the particle diameter of the second binder particle 402 is too small, the second binder particles 402 themselves are prone to agglomerate and bond to each other and thereby fail to sufficiently bond with the second active material particle 401. Consequently, the binder particles concentrate in local regions, thereby affecting the bonding effect. In addition, if the particle diameter of the second binder particle 402 is too small, the second binder particle 402 merely fills packing pores between the second active material particles 401, and is less likely to coat the surface of the second active material particles 401. Consequently, the bonding force between the second binder particle 402 and the second active material particle 401 is relatively low, and the resistance of the active material layer decreases. If the particle diameter of the second binder particle 402 is too large, the specific surface area is reduced, the pores between the second active material particles 401 are unable to be filled efficiently, and pores are generated between the second binder particle and the second active material particle 401. Consequently, the area of coating on the surface of the second active material particle 401 decreases, the gap between the second active material particles 401 is enlarged, the lithium ion transmission path is lengthened, and the electrochemical reaction impedance increases.

It needs to be noted that the particle diameter of the second binder particle 402 means the particle diameter of the second binder particle 402 in a single second composite particle 40. In the electrode plate, when there are a plurality of second composite particles 40, the particle diameter of the second binder particle 402 of all the second composite particles 40 may fall in the range of 0.06 μm to 6 μm; or the particle diameter of the second binder particle 402 of a part of the second composite particles 40 may fall in the range of 0.06 μm to 6 μm.

In some embodiments, the particle diameter range of the first active material particle 301 is 2.31 μm to 30 μm. If the particle diameter of the first active material particle 301 is too small, the specific surface area of the first active material particle 301 is too large, and the side reactions between the first active material particle and the electrolytic solution increase, thereby adversely affecting the cycle performance of the electrochemical device. In addition, if the particle diameter of the first active material particle 301 is too small, the packing pore between the first active material particles 301 is smaller than the size of the first binder particle 302. The filling with the first binder particle 302 increases the distance between the first active material particles 301, and lengthens the electron transmission path. In addition, the conductivity of the first binder particle 302 is relatively low, the electron transmission resistance also increases, and therefore, the electrochemical reaction impedance increases. If the particle diameter of the first active material particle 301 is too large, the pore between the first active material particle 301 and the current collector 20 as well as the pore between the first binder particle 302 and the first active material particle 301 are enlarged. Therefore, the bonding strength between the active material layer 21 and the current collector 20 is reduced. In addition, the larger the particle diameter of the first active material particle 301, the smaller the specific surface area, the lower the reactive sites, and the larger the electrochemical reaction impedance.

It needs to be noted that the particle diameter of the first active material particle 301 means the particle diameter of the first active material particle 301 in a single first composite particle 30. In the electrode plate, when there are a plurality of first composite particles 30, the particle diameter of the first active material particle 301 of all the first composite particles 30 may fall in the range of 2.31 μm to 30 μm; or the particle diameter of the first active material particle 301 of a part of the first composite particles 30 may fall in the range of 2.31 μm to 30 μm.

In some embodiments, the particle diameter range of the second active material particle 401 is 0.1 μm to 2.3 μm. If the particle diameter of the second active material particle 401 is too small, the specific surface area of the second active material particle 401 is too large, and the side reactions between the second active material particle and the electrolytic solution increase, thereby adversely affecting the cycle performance of the electrochemical device. In addition, if the particle diameter of the second active material particle 401 is too small, the packing pore between the second active material particles 401 is smaller than the size of the second binder particle 402. The filling with the second binder particle 402 increases the distance between the second active material particles 401, and lengthens the electron transmission path. In addition, the conductivity of the second binder particle 402 is relatively low, the electron transmission resistance also increases, and therefore, the electrochemical reaction impedance increases. If the particle diameter of the second active material particle 401 is too large, the effective area of coating of the second active material particle 401 coated by the second binder particle 402 is reduced. Therefore, the resistance of the active material layer 21 is reduced significantly, and the short-circuit resistance is reduced when the electrode plate is short-circuited, thereby adversely affecting the improvement of the safety performance of the electrochemical device.

It needs to be noted that the particle diameter of the second active material particle 401 means the particle diameter of the second active material particle 401 in a single second composite particle 40. In the electrode plate, when there are a plurality of second composite particles 40, the particle diameter of the second active material particle 401 of all the second composite particles 40 may fall in the range of 0.1 μm to 2.3 μm; or the particle diameter of the second active material particle 401 of a part of the second composite particles 30 may fall in the range of 0.1 μm to 2.3 μm.

In some embodiments, the active material layer 21 further includes a third binder. The third binder includes at least one of polyacrylic acid sodium salt, polyacrylic acid, polyacrylate, polymethyl methacrylate, polyacrylonitrile, polyamide, or sodium carboxymethyl cellulose. In some embodiments, such third binders are highly adhesive binders, and can further enhance the bonding strength between the active material layer 21 and the current collector 20. In some embodiments, a mass ratio of the polypropylene to the third binder in the active material layer 21 is 1:10 to 10:0.1.

In some embodiments, a mass percent of the first binder particle 302 in the first active material layer 211 is A, and a mass percent of the second binder particle 402 in the second active material layer 212 is B, where A<B. The mass percent of the first binder particle 302 in the first active material layer 211 close to the current collector 20 is made to be lower than the mass percent of the second binder particle 402 in the second active material layer 212 far from the current collector 20, thereby reducing the conductivity of the second active material layer 212 far from the current collector 20, increasing the ohmic resistance of the active material layer 21, and increasing the short-circuit resistance in a case of a short circuit of the electrode plate. In addition, the mass percent of the first binder particle 302 in the first active material layer 211 close to the current collector 20 is relatively low, thereby reducing the transmission resistance of lithium ions in the first active material layer 211. However, depending on the concentration and the transmission path, with respect to the first active material layer 211 close to the current collector 20, the concentration of the lithium ions is relatively low, and the transmission path of the lithium ions is longer, and therefore, the lithium ion transmission resistance in the first active material layer 211 is reduced, and the electrochemical reaction impedance is reduced, thereby improving the kinetic performance of the electrochemical device.

In some embodiments, a ratio of A to B is 1:9 to 2:3. If the ratio of A to B is too low, the bonding strength between the first active material layer 211 and the current collector 20 is relatively low. If the ratio of A to B is too high, the mass percent of the second binder particle 402 in the second active material layer 212 is too low, thereby adversely affecting the increase of the ohmic resistance of the active material layer 21, and adversely affecting the increase of the short-circuit resistance in a case of a short circuit of the electrode plate.

In some embodiments, on a cross section of the electrode plate in a thickness direction of the electrode plate, the number of the first binder particles 301 per unit area of the first active material layer 211 is less than the number of the second binder particles 401 per unit area of the second active material layer 212. Therefore, the number of the first binder particles 301 in the first active material layer 211 close to the current collector 20 is smaller, thereby reducing the transmission resistance of lithium ions in the first active material layer 211 due to relatively low conductivity of the first binder particles 301. In addition, the number of the second binder particles 401 in the second active material layer 212 is larger, thereby increasing the ohmic resistance of the second active material layer 212 and the entire active material layer 21, increasing the short-circuit resistance in a case of a short circuit of the electrode plate, and improving the safety performance of the electrochemical device.

In some embodiments, a microstructure of the active material layer in a thickness direction may be observed and tested by using a scanning electron microscopy (SEM) technique, so as to obtain the quantitative distribution information of the first binder particles 301 in the first active material layer 211 and the second binder particles 401 in the second active material layer 212.

In some embodiments, at least one of the positive electrode plate 10 or the negative electrode plate 12 may be the foregoing electrode plate. When the electrode plate is the positive electrode plate 10, the first active material particle 301 and the second active material particle 401 each is independently selected from at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadium oxide, lithium manganese oxide, lithium nickel oxide, lithium nickel cobalt manganese oxide, lithium-rich manganese-based material, or lithium nickel cobalt aluminum oxide. When the electrode plate is the negative electrode plate 12, the first active material particle 301 and the second active material particle 401 each is independently selected from at least one of artificial graphite, natural graphite, mesocarbon microbead, soft carbon, hard carbon, silicon, tin, a silicon-carbon compound, a silicon-oxygen compound, or lithium titanium oxide.

As mentioned above, an electrochemical device is provided. The electrochemical device includes an electrode assembly 1. The electrode assembly 1 includes a positive electrode plate 10, a negative electrode plate 12, and a separator 11 disposed between the positive electrode plate 10 and the negative electrode plate 12. At least one of the positive electrode plate 10 or the negative electrode plate 12 is any one of the foregoing electrode plates.

In some embodiments, the current collector of the negative electrode plate 12 may be at least one of a copper foil, a nickel foil, or a carbon-based current collector. In some embodiments, a compacted density of an active material layer of the negative electrode plate 12 may be 1.0 g/cm³ to 1.9 g/cm³. If the compacted density of the active material layer is too low, the volumetric energy density of the electrochemical device is impaired. If the compacted density of the active material layer is too high, the passage of lithium ions is adversely affected, the polarization increases, the electrochemical performance is adversely affected, and the electrochemical device is prone to lithium plating during charging. In some embodiments, the active material layer may further include a conductive agent. The conductive agent in the active material layer may include at least one of conductive carbon black, Ketjen black, graphite flakes, graphene, carbon nanotubes, or carbon fiber.

In some embodiments, a mass ratio between the negative active material (such as a silicon-based material and a carbon material), the conductive agent, and the binder (including the first binder particle and the second binder particle) in the active material layer may be (70 to 98):(1 to 15):(1 to 15). Understandably, what is enumerated above is merely an example, and any other appropriate material and mass ratio may apply.

In some embodiments, the positive electrode plate 10 includes a positive current collector and an active material layer disposed on the positive current collector. The active material layer is disposed on one side or both sides of the positive current collector. In some embodiments, the positive current collector may be an aluminum foil, or may be another positive current collector commonly used in the art. In some embodiments, the thickness of the positive current collector may be 1 μm to 200 μm. In some embodiments, the active material layer may be coated on merely a local region of the positive current collector. In some embodiments, the thickness of the active material layer may be 10 μm to 500 μm.

In some embodiments, the active material layer may further include a conductive agent. In some embodiments, the conductive agent in the active material layer may include at least one of conductive carbon black, Ketjen black, graphite flakes, graphene, carbon nanotubes, or carbon fiber. In some embodiments, a mass ratio of the active material, the conductive agent, and the binder in the active material layer may be (70 to 98):(1 to 15):(1 to 15). Understandably, what is enumerated above is merely an example, and the active material layer of the positive electrode plate 10 may adopt any other appropriate material, thickness, and mass ratio.

In some embodiments, the separator 11 includes at least one of polyethylene, polypropylene, polyvinylidene fluoride, polyethylene terephthalate, polyimide, or aramid fiber. For example, the polyethylene includes at least one of high-density polyethylene, low-density polyethylene, or ultra-high-molecular-weight polyethylene. Especially, the polyethylene and the polypropylene are highly effective in preventing short circuits, and improve stability of the battery through a turn-off effect. In some embodiments, the thickness of the separator is within a range of approximately 5 μm to 500 μm.

In some embodiments, a surface of the separator may further include a porous layer. The porous layer is disposed on at least one surface of the substrate of the separator. The porous layer includes inorganic particles and a binder. The inorganic particles are selected from at least one of aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, a diameter of a pore of the separator is within a range of approximately 0.01 μm to 1 μm. The binder in the porous layer is at least one selected from polyvinylidene difluoride, a vinylidene difluoride-hexafluoropropylene copolymer, a polyamide, polyacrylonitrile, polyacrylic ester, polyacrylic acid, sodium polyacrylate, sodium carboxymethyl cellulose, polyvinylpyrrolidone, polyvinyl ether, poly methyl methacrylate, polytetrafluoroethylene, or polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrode assembly of the electrochemical device is a jelly-roll electrode assembly, a stacked electrode assembly, or a folded electrode assembly.

In some embodiments, the electrochemical device includes, but is not limited to, a lithium-ion battery. In some embodiments, the electrochemical device may further include an electrolyte. The electrolyte may be one or more of a gel electrolyte, a solid-state electrolyte, and an electrolytic solution. The electrolytic solution includes a lithium salt and a nonaqueous solvent. The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt is LiPF₆ because it is of a high ionic conductivity and can improve cycle characteristics.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the chain carbonate compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1, 2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or any combination thereof.

In some embodiments of this application, using a lithium-ion battery as an example, the lithium-ion battery is prepared by: winding or stacking the positive electrode plate, the separator, and the negative electrode plate sequentially into an electrode assembly, putting the electrode assembly into a package such as an aluminum plastic film ready for sealing, injecting an electrolytic solution, and performing chemical formation and sealing; Then a performance test is performed on the prepared lithium-ion battery.

A person skilled in the art understands that the method for preparing the electrochemical device (for example, the lithium-ion battery) described above is merely an example. To the extent not departing from the content disclosed herein, other methods commonly used in the art may be used.

An embodiment of this application further provides an electronic device containing the electrochemical device. The electronic device according to the embodiments of this application is not particularly limited, and may be any electronic device known in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, and the like.

Some specific embodiments and comparative embodiments are enumerated below to give a clearer description of this application, using a lithium-ion battery as an example. For ease of description, polypropylene is adopted in the active material layer of the positive electrode plate 10. Based on this, it can be learned that when such a structure is adopted in the active material layer of the negative electrode plate 12, the same effect can be achieved as if the polypropylene is adopted in the active material layer of the positive electrode plate 10.

### Embodiment 1

Preparing a positive electrode plate: Dissolving lithium cobalt oxide (LiCoO₂) particles as a first positive active material, conductive carbon black as a first conductive agent, polypropylene (PP) particles as a first binder, and polyacrylic acid sodium at a mass ratio of 97.5:1:0.6:0.9 in an N-methyl-pyrrolidone (NMP) solution to form a first positive slurry. Using an aluminum foil as a positive current collector, coating the positive current collector with the first positive slurry in an amount of 9.3 mg/cm², and drying the first positive slurry to obtain a first active material layer; and dissolving lithium cobalt oxide (LiCoO₂) particles as a second positive active material, conductive carbon black as a second conductive agent, polypropylene (PP) particles as a second binder, and polyacrylic acid sodium at a mass ratio of 97.5:1:1.4:0.1 in an N-methyl-pyrrolidone (NMP) solution to form a second positive slurry. Coating the first active material layer with the second positive slurry in an amount of 9.3 mg/cm² to obtain a second active material layer, and performing drying, cold pressing, and cutting to obtain a positive electrode plate.

Taking a slice of the prepared positive electrode plate sectioned in the thickness direction, and obtaining an SEM image of the slice, and measuring particle diameters of the polypropylene particles as the first binder, the polypropylene particles as the second binder, the first positive active material particles, and the second positive active material particles by using the SEM image. The particle diameter of a particle here means a diameter of a circle with an area equal to the cross-sectional area of the particle measured in the SEM image. The particle diameter range of the polypropylene particles as the first binder is 0.5 μm to 1 μm, the particle diameter range of the polypropylene particles as the second binder is 0.5 μm to 1 μm, the particle diameter range of the first active material particle is 5 μm to 15 μm, and the particle diameter range of the second positive active material particle is 0.5 μm to 1 μm.

The ratio of the mass percent of the first binder particle in the first active material layer to the mass percent of the second binder particle in the second active material layer is 3:7. On a cross section of the positive electrode plate in a thickness direction, the number of the first binder particles per unit area of the first active material layer is less than the number of the second binder particles per unit area of the second active material layer.

Preparing a negative electrode plate: Dissolving the graphite, the sodium carboxymethyl cellulose (CMC), and the binder styrene butadiene rubber at a mass ratio of 97.7:1.3:1 in deionized water to form an active material layer slurry. Using a 10 μm-thick copper foil as a negative current collector, coating the negative current collector with the negative shiny in an amount of 9.3 mg/cm², and performing drying and cutting to obtain a negative electrode plate.

Preparing a separator: Using 8 μm-thick polyethylene (PE) as a substrate of the separator, coating both sides of the substrate of the separator with a 2 μm-thick aluminum oxide ceramic layer. Finally, coating 2.5 mg of polyvinylidene difluoride (PVDF) as a binder onto both sides that carry the ceramic layer, and performing drying.

Preparing an electrolytic solution: Adding LiPF₆ into a nonaqueous organic solvent in an environment in which a water content is less than 10 ppm, where the mass ratio of ethylene carbonate (EC):diethyl carbonate (DEC):propylene carbonate (PC):acrylate:vinylene carbonate (VC) is 20:30:20:28:2 and the concentration of the LiPF₆ is 1.15 mol/L; and mixing the solution evenly to obtain an electrolytic solution.

Preparing a lithium-ion battery: stacking the positive electrode plate, the separator, and the negative electrode plate sequentially so that the separator is located between the positive electrode plate and the negative electrode plate to serve a function of separation, and winding the stacked materials to obtain an electrode assembly; Putting the electrode assembly in an aluminum plastic film that serves as an outer package, dehydrating the electrode assembly under 80° C., injecting the electrolytic solution, and performing sealing; and performing steps such as chemical formation, degassing, and edge trimming to obtain a lithium-ion battery.

The steps in the embodiments and comparative embodiments are the same as those in Embodiment 1 except changed parameter values. The specific changed parameter values are shown in the following table.

The particle diameter ranges of the polypropylene particles as the first binder and the polypropylene particles as the second binder in Embodiments 2 to 4 and Comparative Embodiments 1 and 2 are different from those in Embodiment 1.

The ratio of the mass percent of the polypropylene particles as the first binder in the first active material layer to the mass percent of the polypropylene particles as the second binder in the second active material layer in Embodiments 5 to 7 and Comparative Embodiment 3 is different from that in Embodiment 1.

The particle diameter range of the lithium cobalt oxide particles as the first active material in Embodiments 8 to 10 and Comparative Embodiment 4 is different from that in Embodiment 1.

The particle diameter range of the lithium cobalt oxide particles as the second active material in Embodiments 11 to 13 and Comparative Embodiment 5 is different from that in Embodiment 1.

The following describes the testing method of each parameter in this application.

Method for Testing the Bonding Strength Between the First Active Material Layer and the Current Collector:

Taking out an electrode plate from a lithium-ion battery, spreading out the electrode plate, drying the electrode plate by leaving it in the natural air for 1 hour, and then cutting out a specimen of 30 mm in width and 150 mm in length by using a knife. Fixing the specimen onto a test fixture of a GoTech tensile testing machine to test the bonding strength, where the peel angle is 90 degrees, the stretching speed is 50 mm/min, and the tensile displacement is 60 mm. When the peeling interface is an interface between the current collector and the first active material layer, the measured result is the bonding strength between the first active material layer and the current collector.

Method for Testing the Resistance of the Active Material Layer:

Taking out an electrode plate from a lithium-ion battery, spreading out the electrode plate, drying the electrode plate by leaving it in the natural air for 1 hour, and then testing the resistance of the active material layer by using a BER1300 resistance tester manufactured by IEST, where the test pressure is 0.35 T and the test time is 50 seconds.

Method for Testing the Electrochemical Reaction Impedance:

Obtaining the electrochemical reaction impedance of the battery by performing electrochemical impedance spectroscopy (EIS).

Table 1 shows parameters and evaluation results in Embodiments 1 to 4 and Comparative Embodiments 1 to 2.

TABLE 1

| | | Ratio of mass | | | | | |
|---|---|---|---|---|---|---|---|
| | Diameter range | percent of | | | | | |
| | of polypropylene | polypropylene | | | | | |
| | particles as | particles as | Diameter range | Diameter range | Bonding strength | | |
| | first binder and | first binder to | of lithium cobalt | of lithium cobalt | between first | | |
| | polypropylene | mass percent of | oxide particles | oxide particles | active material | Resistance | Electrochemical |
| | particles as | polypropylene | as first active | as second active | layer and current | of active | reaction |
| | second binder | particles as | material | material | collector | material | impedance |
| [symbol] ent | (μm) | second binder | (μm) | (μm) | (N/m) | layer (Ω) | (mΩ) |
| | 0.5 to 1 | 3:7 | 5 to 15 | 0.5 to 1 | 93 | 1.72 | 15.5 |
| | 0.1 to 0.6 | 3:7 | 5 to 15 | 0.5 to 1 | 83 | 1.41 | 14.3 |
| | 0.8 to 1.5 | 3:7 | 5 to 15 | 0.5 to 1 | 102 | 1.64 | 15.1 |
| | 1.2 to 2 | 3:7 | 5 to 15 | 0.5 to 1 | 107 | 1.54 | 15.5 |

[symbol]

ive Embodiment

| | | | | | | |
|---|---|---|---|---|---|---|
| 0.02 to 0.05 | 3:7 | 5 to 15 | 0.5 to 1 | 67 | 0.89 | 13.4 |
| 6.5 to 7.6 | 3:7 | 5 to 15 | 0.5 to 1 | 91 | 1.33 | 18.2 |

[symbol]

indicates data missing or illegible when filed

As can be seen from comparison between Embodiments 1 to 4 and Comparative Embodiments 1 to 2, as the particle diameter of the polypropylene particles is less than 0.06 μm, the polypropylene particles are too small, and merely fill packing pores of the active material particles and are less likely to coat the surface of the active material particles, thereby reducing the bonding force between the first active material layer and the current collector, and reducing the resistance of the active material layer. However, the reactive sites of the active material particles increase, and therefore, the electrochemical reaction impedance decreases. When the particle diameter of the polypropylene particles is larger than 6 μm, the polypropylene particles are too large, the specific surface area is reduced, the pores between the active material particles are unable to be filled efficiently, and pores are generated between the polypropylene particle and the active material particle. Consequently, the area of coating on the surface of the active material particle decreases, the gap between the active material particles is enlarged, the lithium ion transmission path is lengthened, and therefore, the electrochemical reaction impedance increases.

Table 2 shows parameters and evaluation results in Embodiments 1 and 5 to 7 and Comparative Embodiment 3.

TABLE 2

| | | Ratio of mass | | | | | |
|---|---|---|---|---|---|---|---|
| | Diameter range | percent of | | | | | |
| | of polypropylene | polypropylene | | | | | |
| | particles as | particles as | Diameter range | Diameter range | Bonding strength | | |
| | first binder and | first binder to | of lithium cobalt | of lithium cobalt | between first | | |
| | polypropylene | mass percent of | oxide particles | oxide particles | active material | Resistance | Electrochemical |
| | particles as | polypropylene | as first active | as second active | layer and current | of active | reaction |
| | second binder | particles as | material | material | collector | material | impedance |
| [symbol] ent | (μm) | second binder | (μm) | (μm) | (N/m) | layer (Ω) | (mΩ) |
| | 0.5 to 1 | 3:7 | 5 to 15 | 0.5 to 1 | 93 | 1.72 | 15.5 |
| | 0.5 to 1 | 2:3 | 5 to 15 | 0.5 to 1 | 105 | 1.28 | 17.6 |
| | 0.5 to 1 | 1:4 | 5 to 15 | 0.5 to 1 | 82 | 1.89 | 14.9 |
| | 0.5 to 1 | 1:9 | 5 to 15 | 0.5 to 1 | 73 | 2.31 | 14.2 |

[symbol]

ive Embodiment

| | | | | | | |
|---|---|---|---|---|---|---|
| 0.5 to 1 | 1:1 | 5 to 15 | 0.5 to 1 | 73 | 1.13 | 19.6 |

[symbol]

indicates data missing or illegible when filed

As can be seen from comparison between Embodiments 1 and 5 to 7 and Comparative Embodiment 3, as the ratio of the mass percent of the first binder particle in the first active material layer to the mass percent of the second binder particle in the second active material layer increases, the conductivity of the second active material layer decreases, and therefore, the ohmic resistance of both the second active material layer and the entire active material layer increases. In addition, the mass percent of the first binder particle in the first active material layer is relatively low, thereby reducing the transmission resistance of lithium ions in the first active material layer. However, depending on the concentration and the transmission path, in the part that is closer to the current collector, the concentration of the lithium ions is lower, and the transmission path of the lithium ions is longer, thereby reducing the lithium ion transmission resistance in the first active material layer and reducing the electrochemical reaction impedance.

Table 3 shows parameters and evaluation results in Embodiments 1 and 8 to 10 and Comparative Embodiment 4.

TABLE 3

| | Diameter range of | Ratio of mass | | | | | |
|---|---|---|---|---|---|---|---|
| | polypropylene | percent of | | | | | |
| | particles as | first binder | Diameter range | Diameter range | Bonding strength | | |
| | first binder and | particles to | of lithium cobalt | of lithium cobalt | between first | Resistance | |
| | polypropylene | mass percent of | oxide particles | oxide particles | active material | of active | Electrochemical |
| | particles as | polypropylene | as first active | as second active | layer and current | material | reaction |
| | second binder | particles as | material | material | collector | layer | impedance |
| [symbol] ent | (μm) | second binder | (μm) | (μm) | (N/m) | (Ω) | (mΩ) |
| | 0.5 to 1 | 3:7 | 5 to 15 | 0.5 to 1 | 93 | 1.72 | 15.5 |
| | 0.5 to 1 | 3:7 | 2.3 to 8 | 0.5 to 1 | 95 | 1.69 | 14.9 |
| | 0.5 to 1 | 3:7 | 8 to 15 | 0.5 to 1 | 87 | 1.72 | 16.1 |
| | 0.5 to 1 | 3:7 | 12 to 30 | 0.5 to 1 | 73 | 1.73 | 17 |

[symbol]

ive Embodiment

| | | | | | | |
|---|---|---|---|---|---|---|
| 0.5 to 1 | 3:7 | 310 to 35 | 0.5 to 1 | 54 | 1.73 | 19.3 |

[symbol]

indicates data missing or illegible when filed

As can be seen from comparison between Embodiments 1 and 8 to 10 and Comparative Embodiment 4, as the particle diameter of the first active material particle increases, the pore between the first active material particle and the current collector as well as the pore between the polypropylene particle and the first active material particle are enlarged. Therefore, the bonding strength between the first active material layer and the current collector is reduced. In addition, the larger the particle diameter of the first active material particle, the smaller the specific surface area, the lower the reactive sites, and the larger the electrochemical reaction impedance. Considering both the bonding strength between the first active material layer and the current collector and the electrochemical reaction impedance, the particle diameter range of the first active material particle may be set to 2.31 μm to 30 μm.

Table 4 shows parameters and evaluation results in Embodiments 1 and 11 to 13 and Comparative Embodiment 5.

TABLE 4

| | | Ratio of mass | | | | | |
|---|---|---|---|---|---|---|---|
| | Diameter range of | percent of | | | | | |
| | polypropylene | polypropylene | | | | | |
| | particles as | particles as | Diameter range | Diameter range | Bonding strength | | |
| | first binder and | first binder to | of lithium cobalt | of lithium cobalt | between first | | |
| | polypropylene | mass percent of | oxide particles | oxide particles | active material | Resistance of | Electrochemical |
| | particles as | polypropylene | as first active | as second active | layer and current | active | reaction |
| | second binder | particles as | material | material | collector | material layer | impedance |
| [symbol] ent | (μm) | second binder | (μm) | (μm) | (N/m) | (Ω) | (mΩ) |
| | 0.5 to 1 | 3:7 | 5 to 15 | 0.5 to 1 | 93 | 1.72 | 15.5 |
| | 0.5 to 1 | 3:7 | 5 to 15 | 0.1 to 0.6 | 93 | 1.78 | 16.3 |
| | 0.5 to 1 | 3:7 | 5 to 15 | 0.8 to 1.5 | 93 | 1.7 | 15.7 |
| | 0.5 to 1 | 3:7 | 5 to 15 | 1.2 to 2.3 | 93 | 1.63 | 15.3 |

[symbol]

ive Embodiment

| | | | | | | |
|---|---|---|---|---|---|---|
| 0.5 to 1 | 3:7 | 5 to 15 | 2.4 to 15 | 93 | 1.49 | 15.1 |

[symbol]

indicates data missing or illegible when filed

As can be seen from comparison between Embodiments 1 and 11 to 13 and Comparative Embodiment 5, as the particle diameter of the second active material particle decreases, the packing pore between the second active material particles is smaller than the size of the polypropylene particle. The filling with the polypropylene particle increases the distance between the second active material particles, and lengthens the electron transmission path. In addition, the conductivity of the polypropylene particle is relatively low, the electron transmission resistance also increases, and therefore, the resistance of the active material layer increases. If the particle diameter of the second active material particle is too large, the effective area of coating of the second active material particle coated by the polypropylene particle is reduced. Therefore, the resistance of the active material layer is reduced significantly, thereby adversely affecting the increase of the short-circuit resistance in a case of a short circuit of the electrode plate.

The foregoing descriptions are merely about exemplary embodiments of this application and the technical principles applied. A person skilled in the art understands that the scope of disclosure in this application is not limited to the technical solutions formed by a specific combination of the foregoing technical features, but also covers other technical solutions formed by arbitrarily combining the foregoing technical features or equivalents thereof, for example, a technical solution formed by replacing any of the foregoing features with a technical feature disclosed herein and serving similar functions.

What is claimed is:

1. An electrode plate, comprising:
a current collector, and
an active material layer, located on the current collector, wherein
the active material layer comprises a first composite particle and a second composite particle, the first composite particle comprises a first active material particle and a first binder particle, the first binder particle and the first active material particle in contact with the first binder particle constitute the first composite particle, the second composite particle comprises a second active material particle and a second binder particle, and the second binder particle and the second active material particle in contact with the second binder particle constitute the second composite particle; in a thickness direction of the material layer, the first composite particle is closer to the current collector than the second composite particle, wherein a number of the first active material particles contained in the first composite particle is smaller than a number of the second active material particles contained in the second composite particle, and both composition of the first binder particle and composition of the second binder particle comprise polypropylene.

2. The electrode plate according to claim 1, wherein the active material layer comprises a first active material layer and a second active material layer, the first active material layer is disposed between the current collector and the second active material layer, the first active material layer comprises the first composite particle, and the second active material layer comprises the second composite particle.

3. The electrode plate according to claim 1, wherein a particle diameter of the first binder particle is 0.06 μm to 6μm, a particle diameter of the second binder particle is 0.06 μm to 6 μm, a particle diameter of the first active material particle is 2.31 μm to 30 μm, and a particle diameter of the second active material particle is 0.1 μm to 2.3 μm.

4. The electrode plate according to claim 1, wherein the active material layer further comprises a third binder, and the third binder comprises at least one of polyacrylic acid sodium salt, polyacrylic acid, polyacrylate, polymethyl methacrylate, polyacrylonitrile, polyamide, or sodium carboxymethyl cellulose.

5. The electrode plate according to claim 2, wherein a mass percent of the first binder in the first active material layer is A, and a mass percent of the second binder in the second active material layer is B, wherein A<B.

6. The electrode plate according to claim 5, wherein a ratio of A to B is 1:9 to 2:3.

7. The electrode plate according to claim 2, wherein, on a cross section of the electrode plate in a thickness direction of the electrode plate, a number of the first binder particles per unit area of the first active material layer is less than a number of the second binder particles per unit area of the second active material layer.

8. The electrode plate according to claim 1, wherein, the electrode plate is a positive electrode plate, and the first active material particle and the second active material particle each is independently selected from at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadium oxide, lithium manganese oxide, lithium nickel oxide, lithium nickel cobalt manganese oxide, lithium-rich manganese-based material, or lithium nickel cobalt aluminum oxide.

9. The electrode plate according to claim 1, wherein the electrode plate is a negative electrode plate, and the first active material particle and the second active material particle each is independently selected from at least one of artificial graphite, natural graphite, mesocarbon microbead, soft carbon, hard carbon, silicon, tin, a silicon-carbon compound, a silicon-oxygen compound, or lithium titanium oxide.

10. An electrochemical device, comprising a positive electrode plate, a negative electrode plate, and a separator disposed between the positive electrode plate and the negative electrode plate;
wherein at least one of the positive electrode plate or the negative electrode plate comprising:
a current collector; and
an active material layer, located on the current collector, wherein
the active material layer comprises a first composite particle and a second composite particle, the first composite particle comprises a first active material particle and a first binder particle, the first binder particle and the first active material particle in contact with the first binder particle constitute the first composite particle, the second composite particle comprises a second active material particle and a second binder particle, and the second binder particle and the second active material particle in contact with the second binder particle constitute the second composite particle; in a thickness direction of the material layer, the first composite particle is closer to the current collector than the second composite particle, wherein a number of the first active material particles contained in the first composite particle is smaller than a number of the second active material particles contained in the second composite particle, and both composition of the first binder particle and composition of the second binder particle comprise polypropylene.

11. The electrochemical device, according to claim 10, wherein the active material layer comprises a first active material layer and a second active material layer, the first active material layer is disposed between the current collector and the second active material layer, the first active material layer comprises the first composite particle, and the second active material layer comprises the second composite particle.

12. The electrochemical device, according to claim 10, wherein a particle diameter of the first binder particle is 0.06 μm to 6 μm, a particle diameter of the second binder particle is 0.06 μm to 6 μm, a particle diameter of the first active material particle is 2.31 μm to 30 μm, and a particle diameter of the second active material particle is 0.1 μm to 2.3 μm.

13. The electrochemical device, according to claim 10, wherein the active material layer further comprises a third binder, and the third binder comprises at least one of polyacrylic acid sodium salt, polyacrylic acid, polyacrylate, polymethyl methacrylate, polyacrylonitrile, polyamide, or sodium carboxymethyl cellulose.

14. The electrochemical device, according to claim 11, wherein a mass percent of the first binder in the first active material layer is A, and a mass percent of the second binder in the second active material layer is B, wherein A<B,

15. The electrochemical device, according to claim 14, wherein a ratio of A to B is 1:9 to 2:3.

16. The electrochemical device, according to claim 11, wherein, on a cross section of the electrode plate in a thickness direction of the electrode plate, a number of the first binder particles per unit area of the first active material layer is less than a number of the second binder particles per unit area of the second active material layer.

17. The electrochemical device, according to claim 10, wherein, the electrode plate is a positive electrode plate, and the first active material particle and the second active material particle each is independently selected from at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadium oxide, lithium manganese oxide, lithium nickel oxide, lithium nickel cobalt manganese oxide, lithium-rich manganese-based material, or lithium nickel cobalt aluminum oxide.

18. The electrochemical device, according to claim 10, wherein the electrode plate is a negative electrode plate, and the first active material particle and the second active material particle each is independently selected from at least one of artificial graphite, natural graphite, mesocarbon microbead, soft carbon, hard carbon, silicon, tin, a silicon-carbon compound, a silicon-oxygen compound, or lithium titanium oxide.

19. An electronic device comprising the electrochemical device, the electrochemical device, comprising a positive electrode plate, a negative electrode plate, and a separator disposed between the positive electrode plate and the negative electrode plate;
wherein at least one of the positive electrode plate or the negative electrode plate is the electrode plate, comprising:
a current collector; and
an active material layer, located on the current collector, wherein
the active material layer comprises a first composite particle and a second composite particle, the first composite particle comprises a first active material particle and a first binder particle, the first binder particle and the first active material particle in contact with the first binder particle constitute the first composite particle, the second composite particle comprises a second active material particle and a second binder particle, and the second binder particle and the second active material particle in contact with the second binder particle constitute the second composite particle; in a thickness direction of the material layer, the first composite particle is closer to the current collector than the second composite particle, wherein a number of the first active material particles contained in the first composite particle is smaller than a number of the second active material particles contained in the second composite particle, and both composition of the first binder particle and composition of the second binder particle comprise polypropylene.

20. An electronic device, according to claim 19, wherein the active material layer comprises a first active material layer and a second active material layer, the first active material layer is disposed between the current collector and the second active material layer, the first active material layer comprises the first composite particle, and the second active material layer comprises the second composite particle.
